(19) United States
(12) Patent Application Publication
(10) Pub. No.: US 2009/0123338 A1
(43) Pub. Date: May 14, 2009

(54) BUBBLE-RESISTANT INJECTOR PORT FOR FLUIDIC DEVICES

(76) Inventors: Xiaosheng Guan, Beijing (CN); Yuming Hu, Beijing (CN); Min Guo, Beijing (CN); Cheng Zhou, Beijing (CN); Jing Cheng, Beijing (CN)

Correspondence Address: MORRISON & FOERSTER LLP, 12531 HIGH BLUFF DRIVE, SUITE 100, SAN DIEGO, CA, 92130-2040, US

(21) Appl. No.: 12/096,020

(22) PCT Filed: Dec. 18, 2006
(86) PCT No.: PCT/CN2006/003471

§ 371 Date: Oct. 22, 2008

(30) Foreign Application Priority Data
Dec. 23, 2005 (CN) 200510130706.0

(51) Int. Cl. B01L 3/00; B32B 37/00

(52) U.S. Cl. 422/100; 156/60

(57) ABSTRACT

An bubble-resistant injector port for fluidic and microfluidic devices includes an air-exhaustion feature to reduce the inclusion of bubbles or voids in injected samples, particularly in samples injected by a micropipette. The air-exhaustion feature comprises an air-exhaustion cavity in gas communication with the injector port through a narrowed channel that permits a flow of air into the cavity, while impeding a flow of injected liquid into the cavity.

### TECHNICAL FIELD

The present invention relates to fluid handling devices, and more particularly to injector ports for introducing samples or reagents into fluidic or microfluidic devices or systems.

### BACKGROUND ART

Fluidic devices can have integrated fluid channels for directing and controlling the transport of fluids. Microfluidics, a miniaturized form of fluidics, has emerged as a new approach for improving performance and functionality of such systems for chemical and biochemical synthesis, as well as chemical, biochemical, and medical analysis. Miniaturization and new effects in micro-scale promise completely new system solutions in these fields. Dimension reduction results in faster processes with reduced reagent and sample consumption rates. The small size scale also encourages parallel processing, in which more compounds can be produced and/or analyzed simultaneously. Massively parallel processing can speed DNA, RNA, protein, immunologic, and other tests to reduce time intervals for drug discovery and medical diagnosis. Currently, microfluidic based microanalysis systems for such applications typically have fluid channel dimensions on the order of tenths of millimeters to several millimeters, although future trends are to further reduce channel dimensions. Various microfluidic components have also been demonstrated on the same size scale, for example: micro-valves, micro-pumps, micro-flow sensors, micro-filters, micro-mixers, micro-reactors, micro-separators, and micro-dispensers, to name just a few. The book, FUNDAMENTALS AND APPLICATIONS OF MICROFLUIDICS by Nam-Trung Nguyen and Steven T. Werely, published by Artech House of Boston, U.S.A., in 2002 provides an overview of some microfluidic technologies and applications.

In the use of microfluidic systems, it is often desirable to volumetrically introduce samples or reagents using a micropipette. Micropipettes typically transfer volumes ranging from fractions of micro liters to hundreds of micro liters. Such micropipettes can be manual or automatic, and single or multi-tipped/channeled. Micropipettes can be robotically controlled. Examples of micropipettes can be examined in product literature from Eppendorf® North America of Westbury, N.Y., U.S.A (www.eppendorf.com).

FIG. 1 shows a side view of a typical manual micropipette 101 for purposes of illustration, although similar operating principles apply to other types of micropipettes, such as discussed above. Micropipette 101 comprises a body 102 having a push button 103 at one end, and a stem 104 at the other end. Hollow tip 105 can interface with stem 104 by a friction fit that is relatively air tight. (Other types of interfaces such as screw or twist-lock are also feasible.) Tip 105 typically tapers to opening 108 for fluid access. Tip 105 is typically removable from stem 104 so that it is easily replaceable. Typically, tips are disposable, and only used once for liquid transfer. In operation, button 103 can be depressed to a first stop and opening 108 of tip 105 immersed in a reservoir of liquid to be aspirated. The liquid is volumetrically aspirated when button 103 is released, and the desired volume of liquid 106 is stored in tip 105. For dispensation, button 103 can be depressed beyond the first stop, to a second stop to expel liquid 106, followed by a volume of air 107 that is also stored in tip 105, to promote more complete expulsion of liquid 106 from tip 105.

FIG. 2 illustrates the use of a micropipette 101 to volumetrically inject a liquid into a microfluidic system 110 at an injector port 142 of microfluidic system 110. Although a manual 112 operation with a single tip micropipette 101 is shown, similar principles apply to other types of micropipettes. During such a micropipette transfer process, air can inadvertently be injected into the microfluidic system through the action of inserting micropipette tip 105 into injector port 142. Additionally, during liquid injection, micropipette 101 can inject a volume of air 107 into injector port 142 following liquid injection to promote more complete volumetric liquid transfer, as discussed above. Such air injection is undesirable because it can introduce air bubbles or voids into an injected liquid sample, once it is in a microfluidic system. In addition to air injected by the pipette, the subsequent sealing of the injector port by adhesive tape or a stopper can also introduce air.

There is another mechanism, often occurring in practice, by which air can get into a channel downstream of an injector port well before a liquid sample is completely injected that can frequently occur if the liquid sample being injected contains surfactants, such as SDS (sodium dodecyl sulfate), BSA (bovine serum albumin), Triton®, and Tween®, to name a few. Such surfactants can decrease an injected liquid's affinity for channel-wall materials, thereby increasing wicking with channel walls and channel-wall edges. Such wicking can entrap air that is already in the channel to form a bubble in an otherwise continuous liquid stream.

Regardless of how air may be introduced in an otherwise continuous liquid stream, it can degrade the functioning of the microfluidic system in downstream analysis or synthesis processes. Consequently, a fluidic or microfluidic injector port that can reduce or eliminate air or gas bubbles or voids in injected liquid samples without appreciably degrading volumetric liquid transfer accuracy and repeatability is very desirable.

### SUMMARY OF THE INVENTION

Embodiments of the present invention provide microfluidic injector ports having desirable features as discussed in the paragraph immediately above.

According to an embodiment of the invention, a fluid injector port comprises: an injector-port cavity, defined by at least one injector-port cavity wall, wherein the injector-port cavity is configured to accept the insertion of a micropipette tip; a downstream channel, defined by at least one downstream-channel wall, and having a downstream-channel first end, wherein the downstream channel is configured to be in fluid communication with the injector-port cavity at the first end of the downstream channel; an air-exhaustion cavity, defined by at least one air-exhaustion cavity wall, wherein the air-exhaustion cavity is configured to be in fluid communication with an ambient atmosphere; an air-exhaustion channel, defined by at least one air-exhaustion channel wall, and having first and second air-exhaustion channel ends, wherein the first air-exhaustion channel end is configured to be in fluid communication with the injector-port cavity, wherein the second air-exhaustion channel end is configured to be in fluid communication with the air-exhaustion cavity, and wherein the air-exhaustion channel is configured to impede the transport of liquid more than it impedes the transport of gasses therethrough; and an upstream channel, defined by at least one upstream-channel wall, and having a upstream-channel first end, wherein the upstream channel is configured to be in fluid communication with the air-exhaustion cavity at the first-end of the upstream channel.

According to some embodiments, at least a portion of the at least one air-exhaustion channel wall comprises a hydrophobic material. According to other embodiments, an interface between the air-exhaustion channel and the air-exhaustion cavity comprises a passive valve. According to still other embodiments, a connecting length of the air-exhaustion channel between the injector-port cavity and the air-exhaustion cavity is configured to be short enough to allow a liquid meniscus trapped within the air-exhaustion channel to be entrained and swept away by a liquid flow from the injector-port cavity to the downstream cavity.

Some embodiments comprise a plurality of structural layers that are bonded together, either directly or adhesively. Layers can comprise polymer materials such as polydimethylsiloxane (PDMS), polymethylmethacrylate (PMMA); polycarbonate (PC); polyoxymethylene (POM); and polyamide (PA), and/or inorganic materials such as silicon and glass.

According to one embodiment, the injector port comprises: first and second layers; wherein side and bottom walls for the upstream channel, air-exhaustion cavity, air-exhaustion channel, injector-port cavity, and downstream channel are formed in a first surface of the first layer; wherein a surface of the second layer that faces the first surface of the first layer, forms top walls for the upstream channel, air-exhaustion channel, and downstream channel; and wherein the second layer comprises first and second through holes configured to substantially align with the side walls of the injector-port cavity and the air-exhaustion cavity, respectively.

According to another embodiment, the injector port comprises: first and second layers; wherein side and bottom walls for the upstream channel, air-exhaustion cavity, air-exhaustion channel, injector-port cavity, and downstream channel are formed in a first surface of the first layer; wherein a surface of the second layer that faces the first surface of the first layer, forms top walls for the upstream channel, air-exhaustion channel, and downstream channel; and wherein the second layer comprises a first through-hole configured to substantially align with the side walls of the air-exhaustion cavity, and a second through-hole configured with a perimeter to extend beyond the perimeter formed by the side walls of the injector port.

According to another embodiment, a method for fabricating a fluid injector port comprises: forming side and bottom walls in a substantially planar surface of a first material layer, the side and bottom walls partially comprising an upstream channel, an air-exhaustion cavity, an air-exhaustion channel, an injector-port cavity, and a downstream channel, wherein the upstream channel is connected to the air-exhaustion cavity, the air-exhaustion cavity is connected to the injector-port cavity, and the injector port cavity is connected to the downstream channel; forming first and second through-holes in a second material layer, the walls of the first and second through-holes being configured to substantially align with the walls of the air-exhaustion cavity and the injector-port cavity, respectively; and bonding the first and second material layers together, according to a bonding method.

According to yet another embodiment, a method for fabricating a fluid injector port comprises: forming side and bottom walls in a substantially planar surface of a first material layer, the side and bottom walls partially comprising an upstream channel, an air-exhaustion cavity, an air-exhaustion channel, an injector-port cavity, and a downstream channel, wherein the upstream channel is connected to the air-exhaustion cavity, the air-exhaustion cavity is connected to the injector-port cavity, and the injector port cavity is connected to the downstream channel; forming first and second through-holes in a second material layer, wherein the walls of first through-hole is configured to substantially align with the side walls of the air-exhaustion cavity, and wherein the walls of the second through-hole are configured with a perimeter to extend beyond the perimeter formed by the side walls of the injector port; and bonding the first and second material layers together, according to a bonding method.

In the above methods, the bonding methods can be direct bonding or adhesive bonding. Mechanical clamping means can also be used for assemblies that may need to be subsequently disassembled for cleaning or maintenance.

In the embodiments described above, one of the structural layers can comprise a substrate, or alternatively be bonded or otherwise attached to a substrate.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 illustrates a manual micropipette.

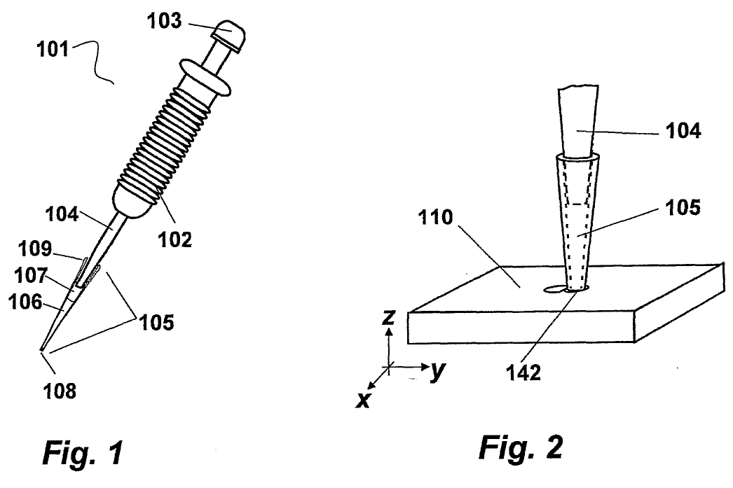

FIG. 2 illustrates a manual micropipette being used to volumetrically introduce a liquid sample into a microfluidic device.

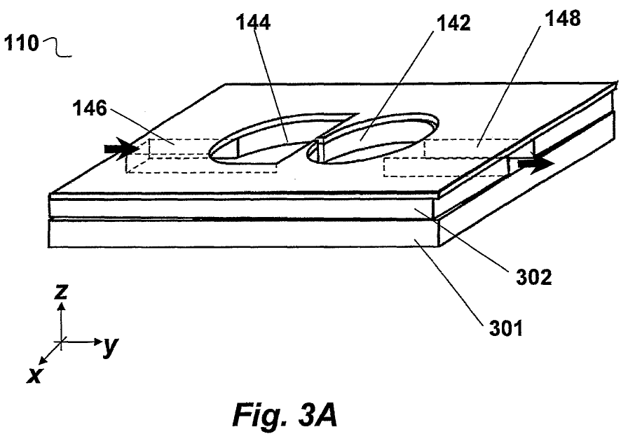

FIG. 3A illustrates a perspective view of a bubble-rejecting injector port according to an embodiment of the invention, and FIG. 3B provides an exploded perspective view of the same embodiment.

FIG. 4A illustrates a top orthogonal view and an aligned, side sectional view of a first component of the embodiment of FIG. 3.

FIG. 4B illustrates a top orthogonal view and an aligned, side sectional view of a second component of the embodiment of FIG. 3.

FIG. 4C is a side sectional view of the embodiment of FIG. 3.

FIG. 5A is a side sectional view of the second embodiment of the invention.

FIG. 5B illustrates aligned top orthogonal and side sectional views of a first component according to second embodiment of the invention.

FIG. 5C illustrates aligned top orthogonal view and side sectional views of a second component according the second embodiment of the invention.

Figures two through five are labeled with coordinate axes that cross reference orientations and views among the figures. When the text herein refers to “top,” it refers to a drawing aspect presenting itself as viewed from the positive y-axis direction. When the text refers to “bottom,” it refers to a drawing aspect presenting itself as viewed from the negative y-axis direction. Although the axes as shown are in particular orientations in the drawings, the actual physical structures illustrated may be rotated to any particular orientation without performance impact, as long as component alignments are maintained and unless otherwise stated.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Commonly designated elements among the various figures refer to common or equivalent elements in the depicted embodiments. The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE INVENTION

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

As used herein, “a” or “an” means “at least one” or “one or more.”

As use herein, “fluid” can refer to matter in a liquid or gaseous state. The terms “air,” “atmosphere,” and “gasses” are used interchangeably.

Embodiments of the microfluidic injector port with bubble trap can be made using techniques that are commonly used to make microfluidic devices and systems. Such techniques span a variety of diverse materials, fabrication, and assembly methods. Materials can be organic or inorganic, and be hydrophobic or hydrophilic to differing extents. A combination of different materials can be used in the same microfluidic device or system. Fabrication methods can be specific to specific types of materials, and can include photolithography; physical, wet, and dry-chemical etching; subtractive and additive material transfer; non-optical transfer printing; contact molding; injection molding; casting; micro-stereo lithography; and micro-machining. Assembly methods can include: anodic, direct, adhesive, and eutectic bonding; and press-fit. The selection of fabrication and assembly method can affect the choice of microfluidic device and system design variations, or vice versa. This will be discussed below in connection with various embodiments of the microfluidic injector port with bubble trap.

As discussed above, various materials, fabrication methods, and assembly techniques can be used in the fabrication of microfluidic devices. The present discussion will focus on a subset of these in relation to embodiments of the current invention for the sake of focus and brevity, although further equivalent embodiments using other materials, fabrication methods, and assembly techniques would be apparent to one of ordinary skill in the art after reading the disclosure.

Inorganic materials include silicon, glasses, metals, and metal alloys. Glass is principally amorphous silicon dioxide (SiO₂) with varying amounts of additional elements in different types of glass. Among the desirable properties of glass for microfluidic device substrates are mechanical strength, dimensional stability, and low cost. A substrate of glass can form an active layer by having channels and other microfluidic structure formed in its surface, or it may merely serve as a mechanical support for active layers of other materials. Surface structures may be formed in glass by wet or dry chemical etching, mechanical ablation or milling, molding, and micromachining. Glass surfaces tend to be hydrophilic.

Typical polymer materials for other microfluidic device layers include thermosetting polymers such as polydimethylsiloxane (PDMS), as well as thermoplastic polymers such as: (i) polymethylmethacrylate (PMMA); (ii) polycarbonate (PC); (iii) polyoxymethylene (POM); and polyamide (PA).

PDMS has an inorganic siloxane backbone with organic methyl groups attached to the silicon. Both prepolymers and curing agents are commercially available. PMDS has a low interfacial free energy, which provides a relatively chemically unreactive, hydrophobic surface, although this can be modified with plasma treatment. PDMS is stable against temperature and humidity. PDMS is transparent, allowing for the visual examination of microfluidic structures and their operations. PDMS is flexible, so it can conform to nonplanar structures. PDMS is optically curable, so micro-stereo lithography can be used to form PDMS microfluidic structures, although PDMS structures can also be cast molded by applying a prepolymer solution to a mold, curing at an elevated temperature, and subsequently peeling the PMDS structure from the mold. The cast molding technique is capable of fabricating relief features down to the order of tens of microns across and deep, and is particularly low cost and does not require large capital investments in manufacturing equipment.

Structures can be formed in the thermoplastic polymers by using compression molding, injection molding, or micro-stereo lithography. Compression molding involves heating the polymer above its glass transition temperature and pressing it against a mold to form relief features, similar to the cast molding technique described in the previous paragraph. Injection molding involves heating the polymer above its glass transition temperature and pressure injecting it into a mold. After cooling, the mold is dismantled, and the molded part is removed.

All of the above fabrication techniques tend to create microfluidic layers with surface features formed in relief. Thus blind holes can be formed, but through holes can require further processing. Through holes (and other through structures) can be drilled by a variety of techniques, such as: (i) laser micro-machining using excimer, Nd:YAG, or CO₂ lasers; (ii) focused ion beam; (iii) micro-electric discharge; (iv) powder blasting; (v) ultrasonic micro-machining; or (vi) reduced-scale mechanical machining, all of which are well known to one of ordinary skill in the art.

Layers and substrate layers as discussed above can be assembled into microfluidic devices and systems using direct or adhesive bonding.

For direct bonding, the surfaces of layers to be bonded are cleaned and the layers are aligned relative to one another and pressed together to form a sandwiched structure. Thermoplastic polymers can be bonded together by heating to temperatures above their glass transition temperature. In cases of thermosetting polymers with low surface energy such as PMDS, layers can be bonded together under pressure at room temperature. PMDS layers can also bond to glass under similar conditions. Another method to bond layers together is wet bonding. In wet bonding, the surfaces to be bonded are wetted with a solvent, and then pressed together. Bonding is accomplished after evaporating the solvent.

In some cases, temporary fluidic device assemble may be accomplished with mechanical clamping of the constituent layers of the device. This approach can be used for situations where disassembly of the device, after use, may be necessary for maintenance or cleaning.

Adhesive bonding uses an intermediate layer to glue layers together. Depending on substrate and layer materials, the intermediate adhesive layer can comprise epoxies, photoresists, or other polymers. The intermediate adhesive layer can be applied to a surface to be bonded, through a removable mask, in order to exclude adhesive from microfluidic structures, as necessary. Techniques for such selective application are well known to one of ordinary skill in the art. Some adhesive layers can be cured by ultraviolet light, while other adhesive layers can be chemically cured, or cured at elevated temperatures.

The embodiment presented here, will describe embodiments using a two layer structure, without loss of generality. One of ordinary skill in the art can readily implement embodiments of the present invention using fewer or more layers after reading this disclosure.

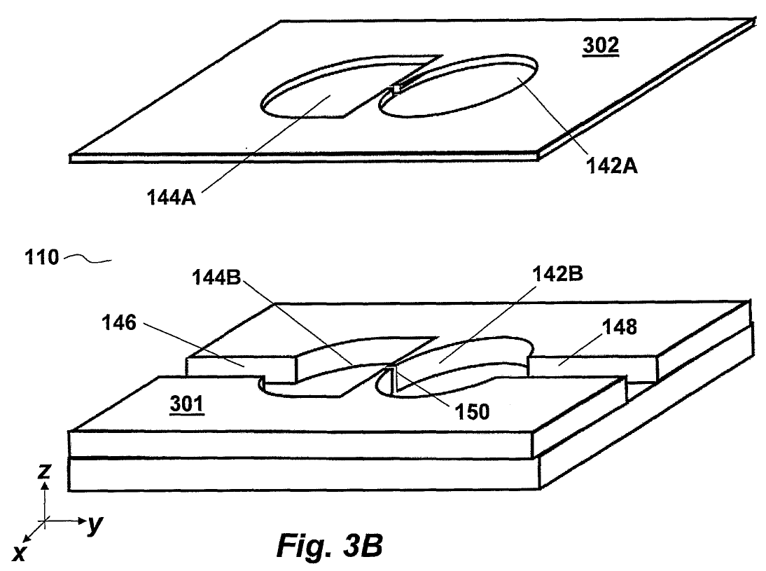

FIG. 3A illustrates a perspective view of a bubble-rejecting injector port according to an embodiment of the invention, and FIG. 3B provides an exploded perspective view of the same embodiment. According to this embodiment, side and bottom walls for upstream channel 146, as well as air exhaustion cavity 144B are formed in the top surface of layer 301. The top wall for upstream channel 146 is provided by the bottom surface of layer 302, when assembled with layer 301. Layer 302 has through hole 144A, configured to substantially align with air-exhaustion cavity 144B, that serves as an air-exhaustion cavity orifice, providing contact between an ambient atmosphere and air-exhaustion cavity 144B. Side and bottom walls for downstream channel 148 and injector-port cavity 142B are likewise formed in the top surface of layer 301, and the top wall for downstream channel 148 is also provided by the bottom surface of layer 302 when assembled with layer 301. Layer 302 has through hole 142B, configured to substantially align with injector-port cavity 142B. Through hole 142B and injector-port cavity 142B are configured to partially accept the insertion of a tapered micropipette tip, but typically not to the point of insertion where the micropipette tip would contact a bottom wall of injector-port cavity 142B, thereby obstructing the micropipette tip's fluid outlet. Upstream channel 146 connects with air-exhaustion cavity 144B, and downstream channel 148 connects with injector-port cavity 142B. Air-exhaustion channel 150 connects air-exhaustion cavity 144B with injector-port cavity 142B. The side and bottom walls of air-exhaustion channel 150 are formed in the top surface of layer 301, and the top wall is provided by a bottom surface of layer 302, when assembled with layer 301.

Continuing to refer to FIGS. 3A and 3B, air-exhaustion channel 150 also has side and bottom walls formed in a top surface of layer 201, and the top wall is provided by a bottom surface of layer 302, when assembled with layer 301. Air-exhaustion channel 150 connects with injector port cavity 142B and air-exhaustion cavity 144B as shown in the figures.

Referring now to FIG. 3C, illustrating aligned top orthogonal view and side sectional views of layer 301, air-exhaustion channel 150 has a length LAC connecting air-exhaustion cavity 144B and injector port cavity 142B. The width and height of air-exhaustion channel 150 are WAC and TCH, respectively. (According to this embodiment, TCH is also the height of upstream channel 146 and downstream channel 148, for simplicity of fabrication. One of ordinary skill in the art can easily appreciate that the heights of air-exhaustion channel 150, upstream channel 146 and downstream channel 148 need not be equal. For example, the bottom walls of the channels can be formed at different depths in the top surface of layer 301, as may be required to interface with different upstream and downstream fluidic processes. Additionally the height of air-exhaustion channel 150 can be reduced in some embodiments as an additional impediment to liquid transport.) LAC is not necessarily drawn to scale with the dimensions of air-exhaustion cavity 144B and injector-port cavity 142B in the figures. According to some embodiments, LAC would be much shorter.

Air-exhaustion channel 150 impedes the flow of injected fluid from injector-port cavity 142B to air-exhaustion cavity 144B according to any one or more of several mechanisms, while allowing for the relatively unimpeded flow of air or gasses for separation from the injected fluid stream.

According to a first mechanism, the width of the air-exhaustion channel, WAC, is narrow enough to discourage liquid transport through the channel, owing to the surface tension of an injected liquid. In some cases, the surface tension of the injected liquid can actually prevent an injected liquid from entering the air-exhaustion channel.

According to a second mechanism, the air-exhaustion channel width to air-exhaustion channel width transition provides a passive valving effect, a phenomenon that is well known to one of ordinary skill in the art. This effect is often casually noticed when, for example, water beads up at an exit orifice of a capillary tube, rather than flowing smoothly from the capillary. In regard to this mechanism, a short LAC can promote the sweeping, by the trailing meniscus of the injected liquid, of any liquid that may have invaded the air-exhaustion channel into the downstream channel—thus reopening a path for subsequent air exhaustion through the air-exhaustion channel.

According to a third mechanism, at least a portion of a surface of the walls of the air-exhaustion channel can be coated with a material having a low affinity, or otherwise treated to reduce affinity, for an injected liquid. As an example, a patch of the lower surface of layer 302 forming a top wall for the air-exhaustion channel can be coated or treated prior to assembly. This can strengthen the passive valving effect described above.

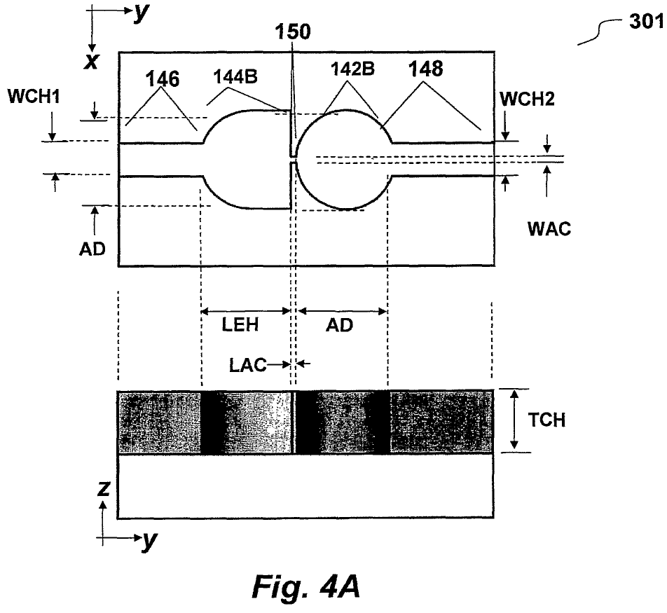

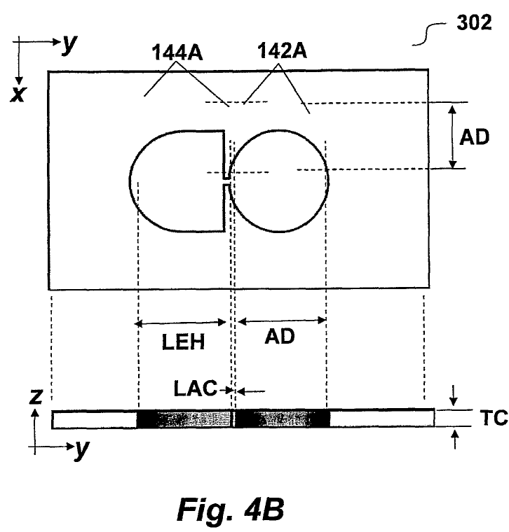

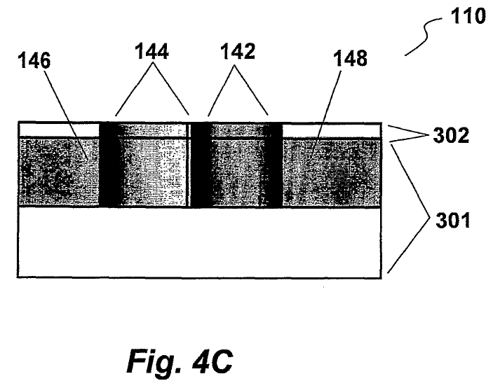

FIG. 4B illustrates aligned top-orthogonal view and side-sectional views of layer 302. As noted previously, through-holes 144A and 142A are configured to substantially align with air-exhaustion cavity 144B and injector-port cavity 142A when layer 302 is assembled with layer 301, as shown in the side sectional view presented in FIG. 4C.

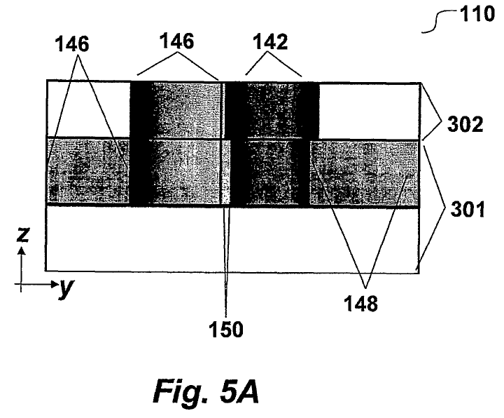

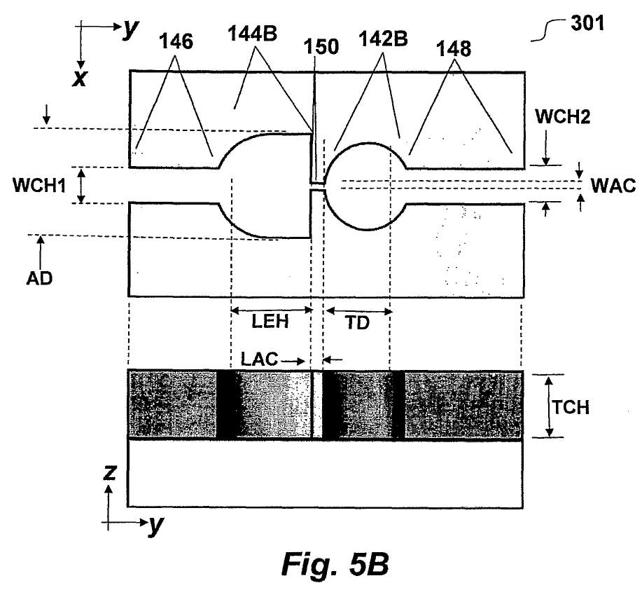

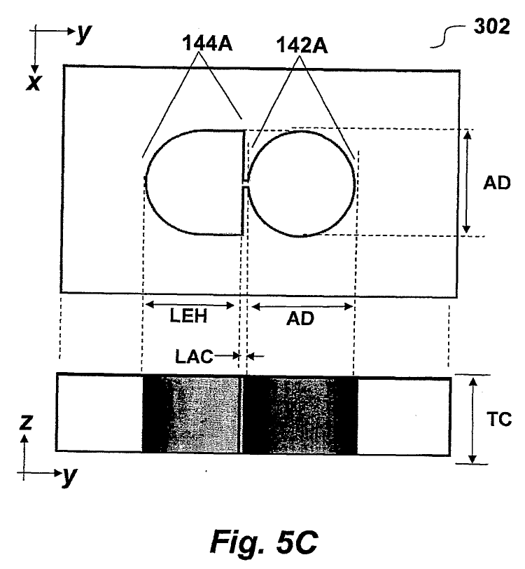

FIG. 5A illustrates a side sectional view according to a second embodiment of the invention. The differences from the first embodiment can be described in reference to FIGS. 5B and 5C presenting aligned top-orthogonal and side-sectional views of layers 301 and 302, respectively. According to the second embodiment, the thickness, TC, of layer 302 is increased so that through-hole 142A accepts the partial insertion of a micropipette tip to align the tip in the x-y plane. The diameter of injector-cavity 142B, TD, is configured smaller than the diameter of through-hole 142A, AD, so as to limit the insertion depth (z-axis position) of the micropipette tip, without blocking the exit orifice of the tip. Otherwise, the second embodiment is as described in relation to the first embodiment.

The second embodiment mechanically aligns an inserted micropipette tip in the x- and -directions through the interface of pipette tip's outer surface and the perimeter of the injector port, with a hard mechanical stop limiting insertion in the z-direction. Whereas the first embodiment mechanically aligns an inserted micropipette tip in the x- and y-directions, as above, but the insertion depth is also limited by mechanical interference between the outside surface of the tip and the perimeter of the injector port.

For the first embodiment, the insertion of the micropipette tip with excessive force could result in mechanical deformation of the tip and/or injector port such that the tip contacts the bottom of the injector port, thereby blocking fluid flow from the tip. However, some mechanical deformation upon tip insertion can promote a liquid-tight seal between the tip and the perimeter of the injector port, which is desirable. A third embodiment that combines desirable features of both the first and second embodiments can be made by configuring the second embodiment such that it functions as the first embodiment for a range normal pipette tip insertion force, but retains the hard mechanical insertion stop of the second embodiment to prevent liquid blockage at the pipette tip in the event of excessive insertion force.

After liquid injection at the injector port, the pipette tip is normally removed, and the injector port and the air-exhaustion hole can be covered with a patch of adhesive tape, or a combination stopper assembly, as can easily be implemented by one of ordinary skill in the art upon reading this disclosure.

Rectangular cross-sections (normal to the direction of fluid flow) for channels have been illustrated in connection with the above described exemplary embodiments. Other channel cross sections will be apparent to one of ordinary skill in the art after studying this disclosure.

It should be understood that the invention can be practiced with modification and alteration within the spirit and scope of the appended claims. The description is not intended to be exhaustive or to limit the invention to the precise form disclosed, or to limit the invention to the exemplary uses described. It should be understood that the invention can be practiced with modification and alteration and that the invention be limited only by the claims and the equivalents thereof.

1. A fluid injector port comprising:
a injector-port cavity, defined by at least one injector-port cavity wall, wherein the injector-port cavity is configured to accept the insertion of a micropipette tip;
a downstream channel, defined by at least one downstream-channel wall, and having a downstream-channel first end, wherein the downstream channel is configured to be in fluid communication with the injector-port cavity at the first end of the downstream channel;
an air-exhaustion cavity, defined by at least one air-exhaustion cavity wall, wherein the air-exhaustion cavity is configured to be in fluid communication with an ambient atmosphere;
an air-exhaustion channel, defined by at least one air-exhaustion channel wall, and having first and second air-exhaustion channel ends, wherein the first air-exhaustion channel end is configured to be in fluid communication with the injector-port cavity, wherein the second air-exhaustion channel end is configured to be in fluid communication with the air-exhaustion cavity, and wherein the air-exhaustion channel is configured to impede the transport of liquid more than it impedes the transport of gasses therethrough; and
an upstream channel, defined by at least one upstream-channel wall, and having a upstream-channel first end, wherein the upstream channel is configured to be in fluid communication with the air-exhaustion cavity at the first-end of the upstream channel.

2. The apparatus of claim 1, wherein at least a portion of the at least one air-exhaustion channel wall comprises a hydrophobic material.

3. The apparatus of claim 1, wherein an interface between the air-exhaustion channel and the air-exhaustion cavity comprises a passive valve.

4. The apparatus of claim 1, wherein a connecting length of the air-exhaustion channel between the injector-port cavity and the air-exhaustion cavity is configured to be short enough to allow a liquid meniscus trapped within the air-exhaustion channel to be entrained and swept away by a liquid flow from the injector-port cavity to the downstream cavity.

5. The apparatus of claim 1, comprising a plurality of structural layers that are bonded together.

6. The apparatus of claim 5, wherein at least one structural layer of the plurality of structural layers comprises a material selected from the group of materials consisting of polymer and inorganic materials.

7. The apparatus of claim 6, wherein the polymer material is selected from the group consisting of at least one of polydimethylsiloxane (PDMS), polymethylmethacrylate (PMMA);
polycarbonate (PC); polyoxymethylene (POM); and polyamide (PA).

8. The apparatus of claim 6, wherein the inorganic material is selected from the group consisting of at least one of silicon and glass.

9. The apparatus of claim 5, comprising:
first and second layers;
wherein side and bottom walls for the upstream channel, air-exhaustion cavity, air-exhaustion channel, injector-port cavity, and downstream channel are formed in a first surface of the first layer;
wherein a surface of the second layer that faces the first surface of the first layer, forms top walls for the upstream channel, air-exhaustion channel, and downstream channel; and
wherein the second layer comprises first and second through holes having walls configured to substantially align with the side walls of the injector-port cavity and the air-exhaustion cavity, respectively.

10. The apparatus of claim 5, comprising:
first and second layers;
wherein side and bottom walls for the upstream channel, air-exhaustion cavity, air-exhaustion channel, injector-port cavity, and downstream channel are formed in a first surface of the first layer;
wherein a surface of the second layer that faces the first surface of the first layer, forms top walls for the upstream channel, air-exhaustion channel, and downstream channel; and
wherein the second layer comprises a first through-hole having walls configured to substantially align with the side walls of the air-exhaustion cavity, and a second through-hole configured with walls having a perimeter to extend beyond the perimeter formed by the side walls of the injector port.

11. A method for fabricating a fluid injector port, comprising:
forming side and bottom walls in a substantially planar surface of a first material layer, the side and bottom walls partially comprising an upstream channel, an air-exhaustion cavity, an air-exhaustion channel, an injector-port cavity, and a downstream channel, wherein the upstream channel is connected to the air-exhaustion cavity, the air-exhaustion cavity is connected to the injector-port cavity, and the injector port cavity is connected to the downstream channel;
forming first and second through-holes in a second material layer, the walls of the first and second through-holes being configured to substantially align with the walls of the air-exhaustion cavity and the injector-port cavity, respectively; and
bonding the first and second material layers together, according to a bonding method.

12. The method of claim 11, wherein the bonding method is selected from the group of bonding methods consisting of direct bonding and adhesive bonding.

13. The method of claim 11, wherein at least one structural layer of the first and second structural layers comprises a material selected from the group of materials consisting of polymer and inorganic materials.

14. The method of claim 13, wherein the polymer material is selected from the group consisting of at least one of polydimethylsiloxane (PDMS), polymethylmethacrylate (PMMA);
polycarbonate (PC); polyoxymethylene (POM); and polyamide (PA).

15. The method of claim 13, wherein the inorganic material is selected from the group consisting of at least one of silicon and glass.

16. A method for fabricating a fluid injector port, comprising:
forming side and bottom walls in a substantially planar surface of a first material layer, the side and bottom walls partially comprising an upstream channel, an air-exhaustion cavity, an air-exhaustion channel, an injector-port cavity, and a downstream channel, wherein the upstream channel is connected to the air-exhaustion cavity, the air-exhaustion cavity is connected to the injector-port cavity, and the injector port cavity is connected to the downstream channel;
forming first and second through-holes in a second material layer, wherein the walls of first through-hole is configured to substantially align with the side walls of the air-exhaustion cavity, and wherein the walls of the second through-hole are configured with a perimeter to extend beyond the perimeter formed by the side walls of the injector port; and
bonding the first and second material layers together, according to a bonding method.

17. The method of claim 16, wherein the bonding method is selected from the group of bonding methods consisting of direct bonding and adhesive bonding.

18. The method of claim 16, wherein at least one structural layer of the first and second structural layers comprises a material selected from the group of materials consisting of polymer and inorganic materials.

19. The method of claim 18, wherein the polymer material is selected from the group consisting of at least one of polydimethylsiloxane (PDMS), polymethylmethacrylate (PMMA); polycarbonate (PC); polyoxymethylene (POM); and polyamide (PA).

20. The method of claim 18, wherein the inorganic material is selected from the group consisting of at least one of silicon and glass.
